(19) United States
(12) Patent Application Publication
(10) Pub. No.: US 2007/0246279 A1
(43) Pub. Date: Oct. 25, 2007

(54) Heat exchanger for motorcycle use

(75) Inventor: Shinya Miura, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/787,645

(22) Filed: Apr. 17, 2007

(30) Foreign Application Priority Data
Apr. 20, 2006 (JP) 2006-116829
Jul. 26, 2006 (JP) 2006-202904

(51) Int. Cl. B60K 11/04

(52) U.S. Cl. 180/68.4

(57) ABSTRACT

A heat exchanger includes: a radiator 1, which is mounted to a motorcycle, having a core portion 15 provided with a plurality of tubes 11 in which cooling water flows and also having a pair of header tanks 13 to which both end portions in the longitudinal direction of the tubes 11 are connected, wherein heat is exchanged between cooling water and air; and a bracket 5 to which the radiator 1 is fixed. The bracket 5 includes: a first fixing portion 51, to which a center frame 2 of the motorcycle is fixed, arranged on one end of the bracket 5; and a second fixing portion 52, to which a cowl 2, with which a motorcyclist comes into contact when riding the motorcycle, is fixed, arranged on the other end side of the bracket 5.

### BACKGROUND OF THE INVENTION

1. Technical Field of the Invention The present invention is related to a heat exchanger mounted on a motorcycle. More specifically, the present invention is related to a heat exchanger mounted on a motocross motorcycle.

2. Description of the Related Art

A conventional radiator mounted on a motorcycle includes: a core portion composed of tubes and fins; header tanks connected to both end portions perpendicular to the core portion; and brackets fixed onto both sides of the core portion. For example, concerning this matter, refer to the official gazette of JP-A-2001-1970.

As shown in FIGS. 1 to 3 of the official gazette of JP-A-2001-1970, both brackets are mounted on a vehicle in such a manner that the brackets are respectively fixed to a center frame (a down tube in the official gazette of JP-A-2001-1970) and a cowl (a cover arranged outside of the radiator) of a vehicle. Both brackets are integrally brazed to the other components of the radiator.

In this connection, in the case where the above radiator is mounted on and used for a motocross motorcycle which is violently vibrated while the motorcycle is running, a motorcyclist knee-grips the motorcycle, that is, a motorcyclist strongly presses both knees into the cowl sides so that the motorcyclist can straddle in a half-sitting manner. Therefore, an excessively heavy load is given to the core portion through the brackets. Accordingly, there is a possibility that the core portion may be deformed as a result of the load.

In order to solve the above problems, it is conventional to enhance the mechanical strength of the brackets, for example, the wall thickness of the brackets is increased or reinforcing parts are added to the brackets so as to enhance durability. In this way, deformation of the core portion is prevented.

However, in the radiator mounted on the motocross motorcycle, the shape of the bracket varies according to the motorcycle or the manufacturer of the motorcycle. Therefore, at the time of assembling the radiator, it is necessary to use a special jig and process corresponding to the bracket with different shape. Accordingly, productivity is deteriorated.

Even when the mechanical strength of the bracket is enhanced, a load is applied by a motorcyclist by knee-gripping of the cowl with the knees, hangs in order of the bracket and the core portion. Therefore, it is necessary for the mechanical strength of the tubes and fins composing the core portion to be enhanced, for example, it is necessary for the wall thickness to be increased. For the above reasons, it is impossible to reduce the wall thickness of the tubes and fins. Accordingly, it is impossible to reduce the weight of the radiator, or to enhance the performance of the radiator.

### SUMMARY OF THE INVENTION

The present invention has been accomplished in view of the above circumstances. It is an object of the present invention to provide a heat exchanger for motorcycle use capable of enhancing performance while ensuring high durability.

It is another object of the present invention to provide a heat exchanger for motorcycle use capable of reducing weight and enhancing performance while ensuring high durability.

In order to accomplish the above object, a heat exchanger mounted on a motorcycle of the present invention includes: a heat exchange portion (1) for exchanging heat between a heating medium and air, having a core portion (15) provided with a plurality of tubes (11) in which the heating medium flows and a pair of header tanks (13) connected to both end portions in the longitudinal direction of the tubes (11); and a bracket (5) to which the heat exchange portion (1) is fixed. The bracket (5) includes: a first fixing portion (51), on one end of which a frame (2) of the motorcycle is fixed; and a second fixing portion (52), on which the other end of a cowl (3), with a portion of the motorcycle which can be contacted when the motorcyclist rides the motorcycle, is fixed.

Due to the above structure, for example, in the case where a load is applied to the cowl (3) side by knee-gripping of the motorcyclist, load is only received by the bracket (5) so that the load cannot be applied to the heat exchange portion (1). Accordingly, it is possible to ensure high durability, and enhance productivity, since a first fixing portion (51) and a second fixing portion (52) of the bracket (5) are formed integrated with each other into one body.

Since durability can be ensured by the brackets (5), it is possible to decrease the mechanical strength of the core portion (15). Therefore, the wall thickness of the tube (11), which is a component of the core portion (15), can be reduced. Accordingly, while high durability is ensured, weight can be reduced and performance can be enhanced.

Since the heat exchange portion (1) and the bracket (5) can be composed separately from each other, after components of the heat exchange portion (1) have been assembled and brazed, the bracket (5) can be assembled. Therefore, irrespective of the type and manufacturer of a motorcycle, shapes such as the core portion (15) and the header tank (13) can be shared. Accordingly, when the shape of the bracket (5) is changed for each manufacturer of a vehicle, it is possible to adapt to the change. Accordingly, productivity can be enhanced.

In the present invention, a portion of the second fixing portion (52) is composed so that it can cover a face opposed to the cowl (3) of the heat exchange portion (1).

Due to the above structure, when the cowl (3) is pushed to the inside of the motorcycle (to the frame (2) side) by knee-gripping of the motorcyclist, the cowl (3) comes into contact with only the second fixing portion (52) and does not come into contact with the heat exchange portion (1). Due to the foregoing, at the time of knee-gripping, load is transmitted from the knees of the motorcyclist to the cowl (3) and the bracket (5) in this order. However, the transmission of the load can be suppressed at the bracket (5) and not directly transmitted to the heat exchange portion (1). Therefore, it is possible to ensure higher durability.

In the present invention, the bracket (5) is arranged so that it can be opposed to a ventilating face of the heat exchange portion (1).

When the above structure is adopted, it is not necessary to increase space, in which the tubes (11) are mounted in the laminating direction, to be larger than the space of a conventional structure in which the bracket (5) is not provided. Therefore, mounting of the heat exchanger can be enhanced.

The first fixing portion (51) and the second fixing portion (52) can be respectively arranged so that they can adapt to both sides which are perpendicular to the ventilating face of the heat exchange portion (1).

The frame is a center frame (2) arranged at the center of a motorcycle. Two heat exchange portions (2) are arranged so that the center frame (2) can be interposed between the two heat exchange portions (2). Alternatively, one heat exchange portion (2) is arranged on one side of the center frame (2). Due to the above arrangement, when a motorcyclist rides a motorcycle, load is put on the center frame (2) through the side of the cowl (3) and the bracket (5) from legs of the motorcyclist.

In the present invention, two brackets (5) are arranged so that the brackets (5) can respectively adapt to a pair of header tanks (13).

Due to the foregoing, it is not necessary to change an arrangement of the core portion (15), the number of parts of which is numerous and assembling which is complicated. Therefore, it is possible to enhance productivity.

In this connection, reference marks in the parentheses of each means described above correspond to the specific means shown in the embodiments described later.

The present invention may be more fully understood from the description of preferred embodiments of the invention, as set forth below, together with the accompanying drawings.

### BRIEF DESCRIPTION OF THE DRAWINGS

In the drawings:

FIG. 1 is a view showing a radiator 1, which is mounted on a motorcycle, of the first embodiment;

FIG. 2 is a front view showing the radiator 1 of the first embodiment, wherein the view is taken from the downstream side of an air flow, that is, from the rear of the motorcycle;

FIG. 3 is a view taken in the direction of arrow A in FIG. 2;

FIG. 4 is a view taken in the direction of arrow B in FIG. 2;

FIG. 5 is a view taken in the direction of arrow C in FIG. 2;

FIG. 6 is a front view of a comparative example;

FIG. 7 is a front view showing a radiator 1 of the second embodiment, wherein the view is taken from the downstream side of air flow, that is, from the rear of a motorcycle;

FIG. 8 is a view taken in the direction of arrow D in FIG. 7;

FIG. 9 is a view taken in the direction of arrow E in FIG. 7;

FIG. 10 is a view taken in the direction of arrow F in FIG. 7; and

FIG. 11 is a view taken in the direction of arrow G in FIG. 7.

### DESCRIPTION OF THE PREFERRED EMBODIMENTS

### First Embodiment

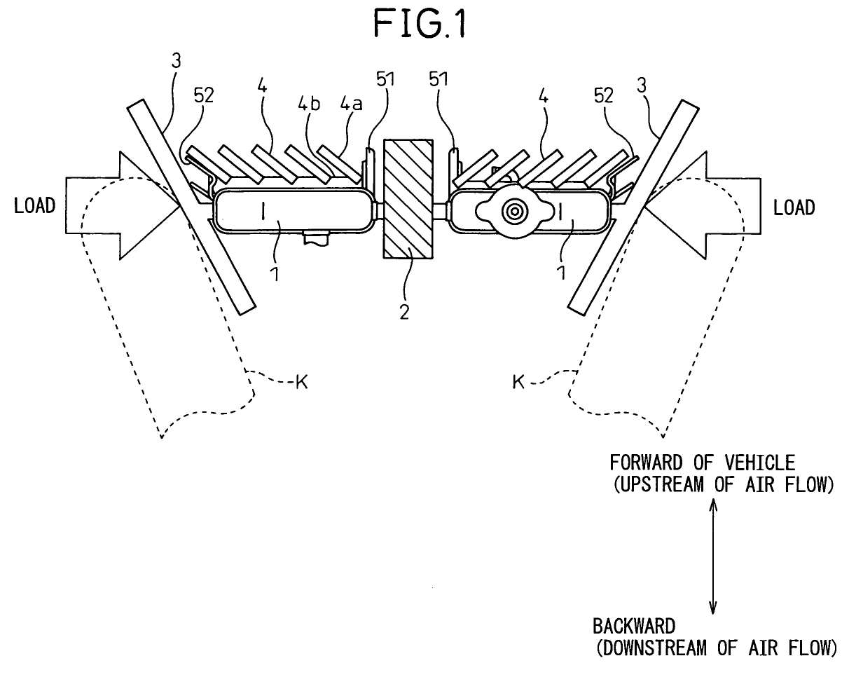

Referring to FIGS. 1 to 6, the first embodiment of the present invention will be explained below. In this embodiment, the present invention is applied to a radiator 1 and a bracket 5 mounted on a motorcycle, which will be also referred to as a vehicle hereinafter, used for motocross. In this connection, the radiator 1 corresponds to a heat exchange portion of the present invention.

FIG. 1 is a view showing a radiator 1, which is mounted on a motorcycle, of the present embodiment. In this connection, FIG. 1 is a view taken from the upper side of the vehicle.

As shown in FIG. 1, the motorcycle includes: a center frame 2, which obliquely extends downward at a central portion of the rear of a front wheel not shown in the drawing; and a cowl 3 arranged on the inside of the knees K of a motorcyclist. The radiator 1 is arranged in the cowl 3 and fixed to the center frame 2 and the cowl 3. On the upstream side (on the front side of the vehicle) of the air flow of the radiator 1, a louver 4 is arranged for preventing mud from splashing over the radiator 1.

In this structure, two radiators 1 are provided. One radiator 1 is arranged on the left side of the center frame 2 and the other radiator 1 is arranged on the right side of the center frame 2. The following explanations will be made regarding the structure of the radiator on the basis of the radiator 1 arranged on the left side of a motorcycle.

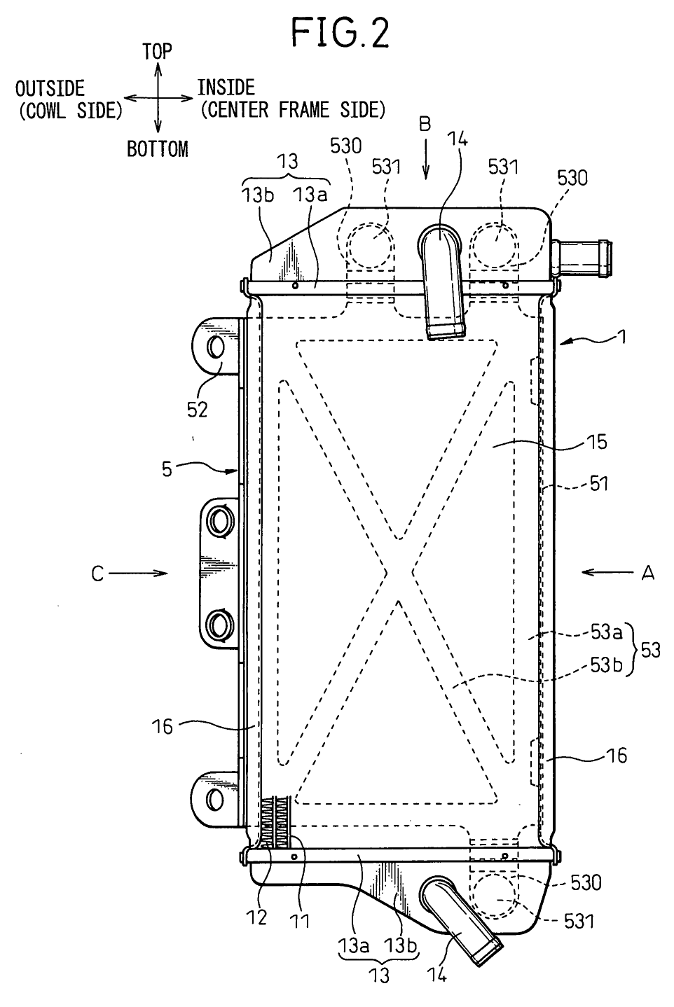

FIG. 2 is a front view showing the radiator 1 of the present embodiment, wherein the view is taken from the downstream side of an air flow, that is, from the rear of a motorcycle. In this connection, in FIG. 2, the bracket 5, which will be described later, is shown by broken lines, because the bracket 5 is arranged on the upstream side of the air flow of the radiator 1.

As shown in FIG. 2, the radiator 1 includes: a plurality of tubes 11 in which cooling water (a heating medium) is circulated; corrugated fins 12 joined onto the outer surfaces of the tubes 11; header tanks 13 arranged on both sides of in the longitudinal direction of the tubes 11 and communicated with the plurality of tubes 11; and connection pipes 14 joined to the header tanks 13 and connected to outer pipes. In the present embodiment, all parts composing the radiator 1 such as tubes 11, fins 12, header tanks 13 and connection pipes 14 are made of aluminum alloy. All the parts are joined to each other being integrated into one body by means of brazing. In this connection, the substantially rectangular heat exchange portion, which is composed of the tubes 11 and the fins 12, is referred to as a core portion 15.

The header tanks 13 extend in a direction perpendicular to the longitudinal direction of the tubes 11 at both end portions in the longitudinal direction of the tubes 11 and are communicated with a plurality of tubes 11. Each header tank 13 includes: a core plate 13a onto which the tubes 11 are inserted; and a tank body 13b composing a tank space together with the core plate 13a. In this connection, the header tank 13 arranged on the upper side of the drawing is used for distributing and supplying cooling water to the tubes 11, and the header tank 13 arranged on the lower side of the drawing is used for collecting and recovering cooling water which has completed heat exchange.

In both end portions of the laminating direction (the lateral direction of the vehicle) of the tubes 11 of the core portion 15, inserts 16 are provided which extend substantially parallel with the longitudinal direction of the tubes 11 and reinforce the core portion 15. The inserts 16 are integrally joined to parts composing the radiator 1 such as tubes 11, fins 12, etc.

On the upstream side of the air flow of the radiator 1, a bracket 5 is provided. The bracket 5 is an attaching member for fixing the radiator 1 to the center frame 2 and the cowl 3. The bracket 5 is a separate body from the radiator 1.

The structure of the bracket 5 will be explained below in detail.

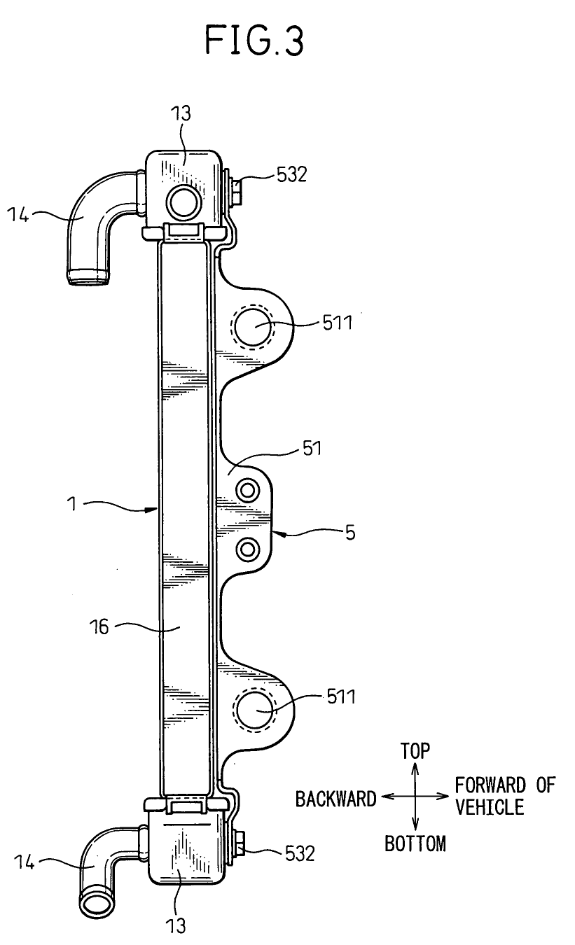

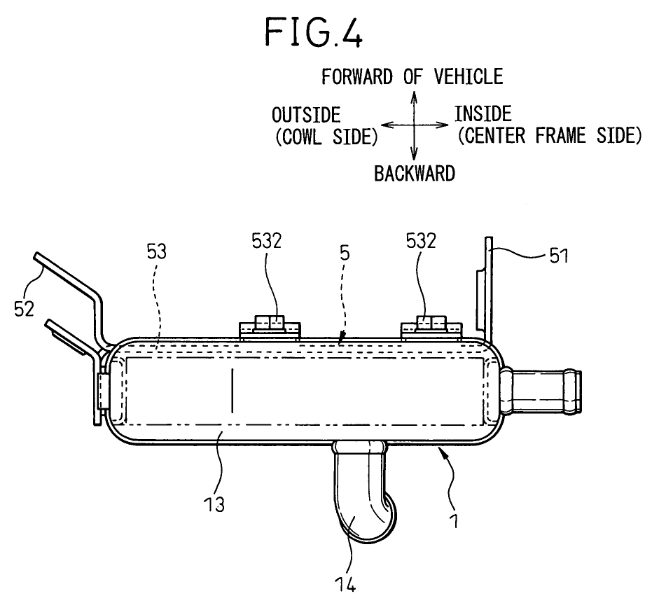

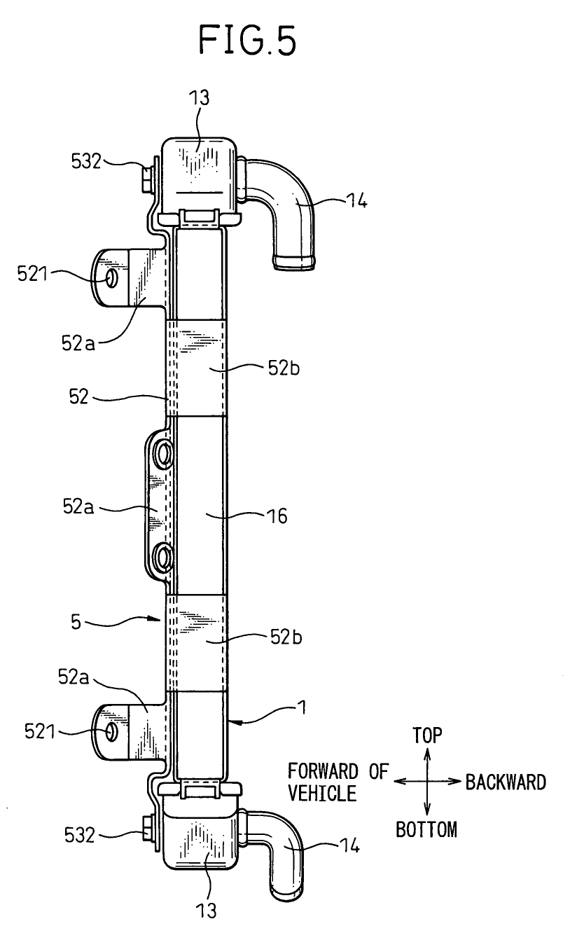

FIG. 3 is a view taken in the direction of arrow A in FIG. 2, FIG. 4 is a view taken in the direction of arrow B in FIG. 2, and FIG. 5 is a view taken in the direction of arrow C in FIG. 2. As shown in FIGS. 2 to 5, the bracket 5 includes: a first fixing portion 51 for fixing the radiator 1 to the center frame 2; a second fixing portion 52 for fixing the radiator 1 to the cowl 3; and a connection member 53 for connecting the first fixing portion 51 to the second fixing portion 52 so as to fix the radiator to the cowl 3. Members 51 to 53 are made of aluminum alloy and integrated with each other into one body.

As shown in FIGS. 2 and 3, connection member 53 is arranged so that connection member 53 can be opposed to a face on the upstream side of the air flow of the radiator 1. The connection member 53 includes: a square frame portion 53a, and a reinforcing portion 53b, which is a brace member, provided diagonally in the frame portion 53a. That is, the reinforcing portion 53b is formed into an X-shape. When a view is taken in the direction of the air flow, the connection member 53 is arranged so that the X-shape of the reinforcing portion 53b can be substantially overlapped on the diagonal line of the core portion 15. Due to the above structure, the radiator 1 is reinforced, especially the core portion 15 is reinforced so that the radiator 1 can withstand a load given in the lateral direction of the vehicle. Since the reinforcing portion 53b does not cover all of the core portion 15, an air flow passing in the core portion 15 is not obstructed.

In a portion corresponding to the header tank 13 of the connecting member 53, a punch stretch formed portion 530 is provided. In the punch stretch formed portion 530, a radiator attaching hole 531 is formed. Into the radiator attaching hole 531, a bolt 532 for the radiator is inserted. The connection member 53 is fixed to the header tank 13. Due to the above structure, the bracket 5 can be fixed to the radiator 1.

As shown in FIGS. 3 and 4, the first fixing portion 51 extends from an end portion on the inside of the vehicle of the connection member 53 to the upstream side of the air flow. In the present embodiment, the first fixing portion 1 is arranged corresponding to the side on the inside in the lateral direction of the vehicle of the radiator 1. Further, the first fixing portion 1 is arranged parallel with the direction of the air flow. In the first fixing portion 51, a vehicle attaching hole 511 is formed. Into the vehicle attaching hole 511, a bolt for vehicle use (not shown) is inserted through a grommet (not shown), which can be elastically deformed, and through a collar (not shown) made of metal. The first fixing portion 51 is fixed to the center frame 2. Due to the above structure, the radiator 1 can be fixed to the center frame 2 through the bracket 5.

As shown in FIGS. 3 and 5, the second fixing portion 52 includes: an upstream side member 52a extending from an end portion on the outside of the vehicle of the connecting member 53 to the upstream side of the air flow; and a downstream side member 52b extending from an end portion on the outside of the vehicle of the connecting member 51 to the downstream side of the air flow of the radiator 1 along outer face of the vehicle.

In the upstream side member 52a, a cowl attaching hole 521 is formed. Into the cowl attaching hole 521, a bolt (not shown) for the cowl is inserted. The second fixing portion 52 is fixed to the cowl 3. Due to the above structure, the radiator 1 can be fixed to the cowl 3 through the bracket 5. In the present embodiment, the upstream side member 52a is inclined toward the outside of the vehicle.

The downstream side member 52b is arranged so that it can cover a portion of the face (the insert 16 arranged on the cowl 3 side), which is opposed to the cowl 3, of the core portion 15. Due to the above structure, when the cowl 3 is moved to the inside of the vehicle by the knee-gripping action of a motorcyclist, the cowl 3 comes into contact with only the downstream side member 52b of the bracket 5 and does not come into direct contact with the core portion 15 of the radiator 1.

As explained above, when the bracket 5, which includes the first fixing portion 51 for fixing the radiator 1 to the center frame 2, and also includes the second fixing portion 52 for fixing the radiator 1 to the cowl 3, is provided, in the case where a load is applied from the cowl 3 side by the knee-gripping action of the motorcyclist, the load can be received only by the bracket 5, that is, the load cannot be applied to the core portion 15 of the radiator 1. To be more specific, the load applied at the time of knee-gripping is transmitted in the order of the second fixing portion 52, the connecting member 53 and the first fixing portion 51. Therefore, the load applied at the time of knee-gripping is not directly transmitted to the radiator 1. Accordingly, it is possible to ensure high durability, and since members 51 to 53 of the bracket 5 can be integrally formed into one body, productivity can be enhanced. Accordingly, while high durability is ensured, productivity can be enhanced.

When the bracket 5 is formed separately from the radiator 1, the bracket 5 can be attached to the radiator 1 after components of the radiator 1 have been assembled and brazed to each other. Therefore, irrespective of vehicle type or manufacturer, a shape of the radiator 1 can be shared. Accordingly, only when a shape of the bracket 5 is changed for each vehicle type and manufacturer, it is possible to adapt to change. Accordingly, productivity can be enhanced.

When an X-shaped reinforcing portion 53b is provided in the connecting member 53, the bracket 5 can bear a load applied from the cowl side. Due to the foregoing, it is possible to ensure higher durability.

When a downstream side member 51b in the second fixing portion 52 of the bracket 5 is composed so that outer face of the vehicle of the core portion 15, that is, a portion of the insert 16 arranged on the cowl 3 side can be covered with the downstream side member 51b, in the case where the cowl 3 is pushed into the vehicle by knee-gripping of a motorcyclist, the cowl 3 comes into contact with only the downstream side member 51b and does not come into contact with the core portion 15 of the radiator 1. Due to the foregoing, at the time of knee-gripping, load is transmitted from the knees K of the motorcyclist to the cowl 3 and the bracket 5 in this order. However, the transmission of the load is stopped at the bracket 5, that is, the load is not directly transmitted to the core portion 15. Therefore, it is possible to ensure higher durability.

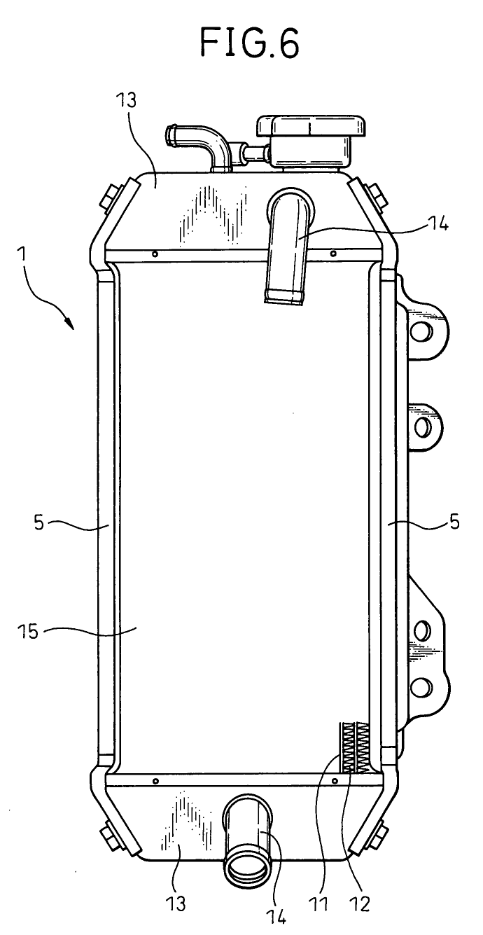

In this connection, FIG. 6 is a view showing a comparative example. In this example, the bracket 5 is arranged outsides of the tube 11 laminating direction in the radiator 1 both. In this case, it is necessary to extend a mounting space in the tube laminating direction by an amount corresponding to the bracket 5. Accordingly, mounting becomes more difficult.

On the other hand, according to the present embodiment, the bracket 5 is arranged on the upstream side of the air flow of the radiator 1. Accordingly, it is not necessary to extend a mounting space in the tube 11 laminating direction. Therefore, mounting can be enhanced.

As described above, it is possible to ensure the durability of the radiator 1 by the bracket 5. Accordingly, mechanical strength of the core portion 15 can be reduced. Due to the foregoing, the wall thickness of the tube 11 and fin 12 can be decreased. Accordingly, while high durability is being ensured, the weight of the radiator 1 can be decreased and further the performance of the radiator 1 can be enhanced.

### Second Embodiment

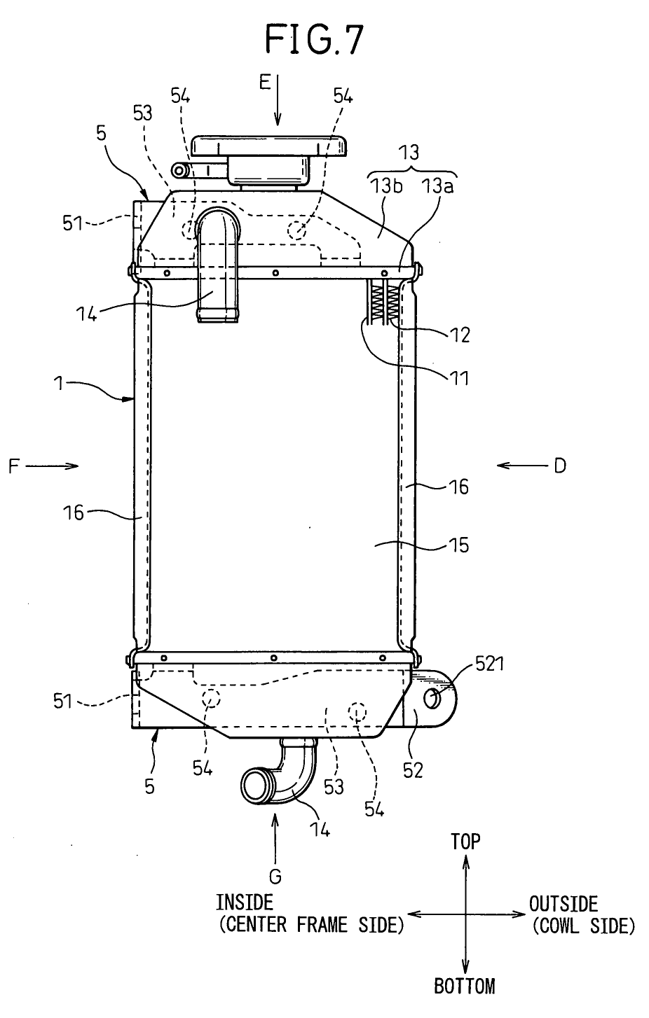

Next, referring to FIGS. 7 to 11, the second embodiment of the present invention will be explained below. Like reference marks are used to indicate like parts in the first and the second embodiment and explanations are omitted hereafter.

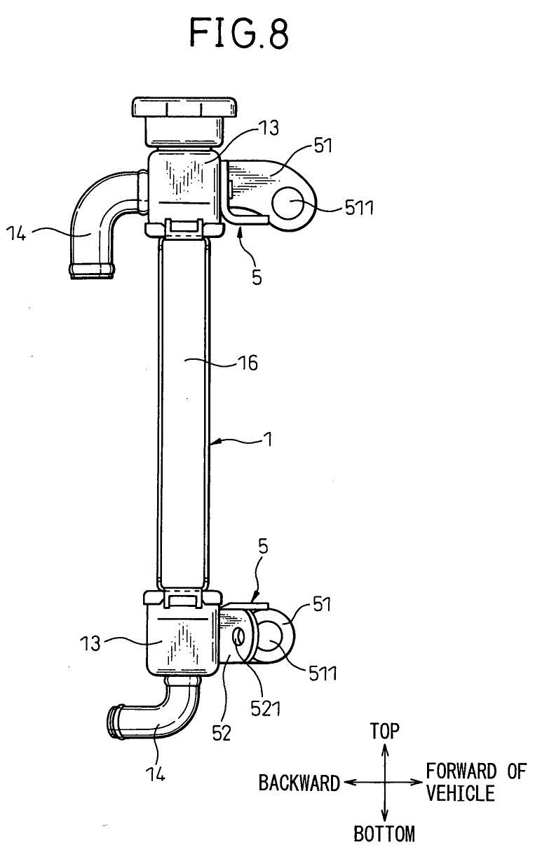

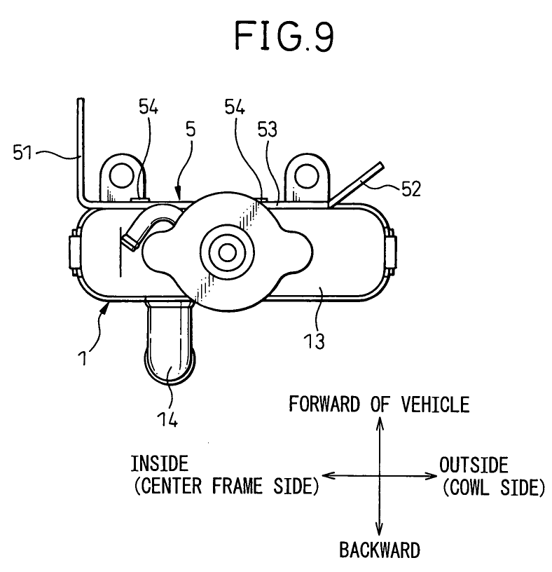

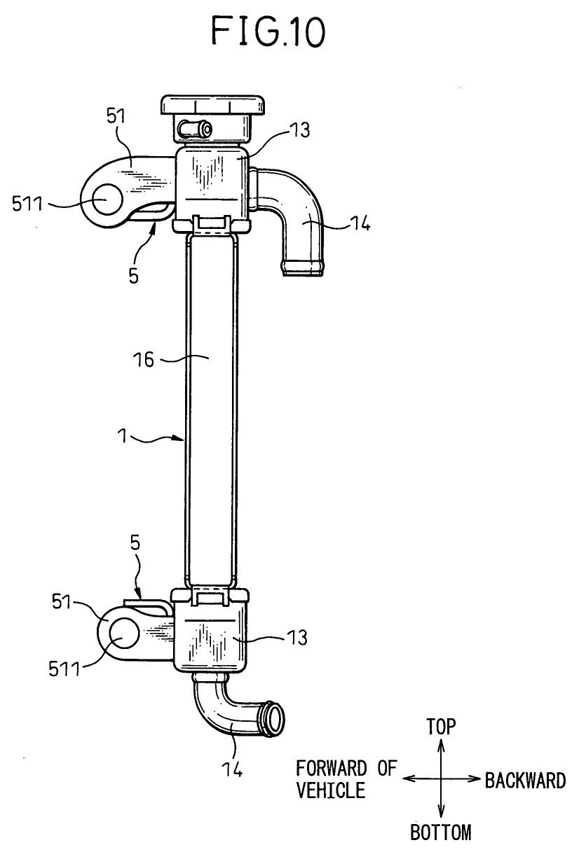

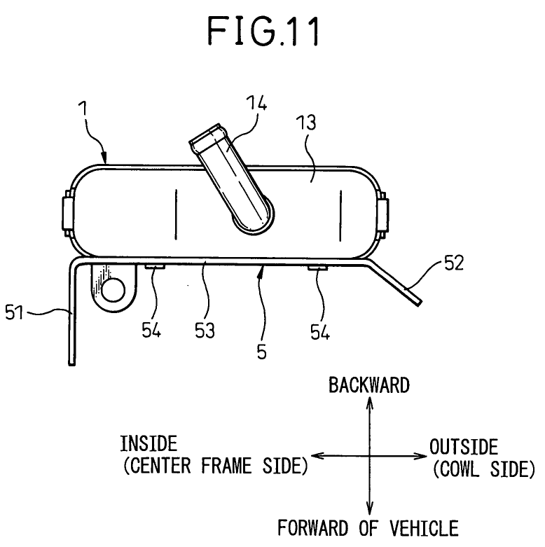

FIG. 7 is a front view showing a radiator 1 of the second embodiment, wherein the view is taken from the downstream side of air flow, that is, from the rear of a vehicle. In this connection, in FIG. 7, the bracket 5 is arranged on the upstream side of the air flow of the radiator 1, and the bracket 5 is shown by broken lines. FIG. 8 is a view taken in the direction of arrow D in FIG. 7, FIG. 9 is a view taken in the direction of arrow E in FIG. 7, FIG. 10 is a view taken in the direction of arrow F in FIG. 7, and FIG. 11 is a view taken in the direction of arrow G in FIG. 7.

As shown in FIGS. 7 to 11, in this embodiment, two brackets 5 are arranged corresponding to a pair of header tanks 13 of the radiator 1. To be more specific, two connection members 53 of the brackets 5 are respectively arranged in portions opposed to the header tanks 13, that is, two connection members 53 of the brackets 5 are not opposed to the core portion 15.

Next, explanations will be made into a method of fixing the radiator 1 to the bracket 5 of this embodiment.

First, the connection pipe 14 is temporarily fixed to the header tank 13. At the same time, the connection member 53 of the bracket 5 is temporarily fixed to the header tank 13 with a rivet 54. The header tank 13 in this state, in which the connection pipe 14 and the bracket 5 are temporarily fixed to the header tank 13, is temporarily assembled to the heat exchanger structure shown in FIG. 7 together with the core portion 15. When this temporarily assembled structural body is conveyed into a heating furnace and integrally brazed, the radiator 1 and the bracket 5 are fixed to each other.

As explained above, when the bracket 5, which includes the first fixing portion 51 for fixing the radiator 1 to the center frame 2, and also includes the second fixing portion 52 for fixing the radiator 1 to the cowl 3, is fixed to the header tank 13, in the case where a load is applied from the cowl 3 side by knee-gripping conducted by the motorcyclist, the load can only be received by the bracket 5, that is, the load cannot be applied to the core portion 15 of the radiator 1. To be more specific, the load applied at the time of knee-gripping is transmitted in the order of the second fixing portion 52, the connecting member 53 and the first fixing portion 51. Therefore, the load applied at the time of knee-gripping is not directly transmitted to the core portion 15. Accordingly, high durability can be ensured. Since members 51 to 53 of the bracket 5 can be integrally formed, productivity can be enhanced. Accordingly, while high durability is ensured, productivity can be enhanced.

When two brackets 5 are provided corresponding to a pair of header tanks 13 so that the brackets 5 make them not oppose to the core portion 15, it is not necessary to change an arrangement of the core portion 15, the number of parts of which is large and the assembly work of which is complicated. Therefore, it is possible to enhance productivity.

When the header tank 13 is temporarily fixed to the connection pipe 14, the bracket 5 can be temporarily fixed at the same time. Therefore, the manufacturing man-hours need not be newly added. Accordingly, the productivity can be improved further.

When the bracket 5, the mechanical strength of which is higher than that of the core portion 15, is fixed to the header tank 13, durability can be further enhanced.

In this connection, concerning the heat exchanger mounted on a motorcycle used for racing (motocross), reduction of the weight is further required. In the present embodiment, when the bracket 5 is fixed to the header tank 13 by means of brazing, fixing members such as a bolt and nut needed for fixing the bracket 5 to the radiator 1 can be eliminated. Therefore, the number of parts can be decreased and weight can be reduced.

In this connection, FIG. 6 shows a comparative example, the bracket 5 is arranged outsides of the tube 11 laminating direction in the radiator 1 both. In this structure, it is necessary to expand a mounting space in the laminating direction of the tubes 11 by an amount corresponding to the bracket 5. Therefore, mounting becomes more difficult.

On the other hand, according to the second embodiment, the bracket 5 is arranged in such a manner that it is opposed to a face on the upstream side of the air flow of the header tank 13. Accordingly, it is not necessary to extend a mounting space in the tube 11 laminating direction. Therefore, mounting can be enhanced.

As described above, it is possible to ensure the durability of the radiator 1 by the bracket 5. Accordingly, mechanical strength of the core portion 15 can be reduced, and as a result, the wall thickness of the tube 11 and the fin 12 can be reduced. Accordingly, while high durability is ensured, the weight of the radiator 1 can be decreased and the performance of the radiator 1 can be enhanced.

### Another Embodiment

In each embodiment described above, the bracket 5 is made of aluminum alloy. However, it should be noted that the material of the bracket 5 is not limited to aluminum alloy. For example, the bracket 5 may be made of another metal such as iron. Alternatively, the bracket 5 may be made of resin.

In each embodiment described above, the present invention is applied to a radiator 1, which is used as a heat exchanger for motorcycle use. However, it should be noted that the present invention does not necessarily have to be applied to the radiator 1, for example, the present invention may be applied to other oil cooler etc.

In each embodiment described above, the bracket 5 is arranged on the upstream side of the air flow of the radiator 1. However, the bracket 5 may be arranged on the downstream side of the air flow.

In each embodiment described above, the radiator 1 is fixed to the center frame 2. However, the radiator 1 does not necessarily have to be fixed to the center frame 2, for example, the radiator 1 may be fixed to a down-tube.

In each embodiment described above, two radiators 1 are arranged in such a manner that the center frame 2 is interposed between the radiators 1. However, it should be noted that the present invention is not limited to the above specific structure. Only one radiator 1 may be arranged either on the right or on the left of the center frame 2.

In the first embodiment described above, the reinforcing portion 53b is formed into an X-shape and arranged so that the X-shape can overlap the diagonal lines of the core portion 15 when a view is taken in the direction of the air flow. However, it should be noted that the present invention is not limited to the above specific embodiment. As long as it is possible to reinforce the radiator 1 (especially, the core portion 15), an arbitrary structure can be adopted.

While the invention has been described with reference to specific embodiments chosen for the purpose of illustration, it should be apparent that numerous modifications could be made thereto, by those skilled in the art without, departing from the basic concept and scope of the invention.

1. A heat exchanger for motorcycle use, comprising:
a core portion, in which a heating medium flows, having a plurality of laminated tubes, for exchanging heat between a moving air and the heating medium;
a pair of header tanks connected to end portions in the longitudinal direction of the tubes; and
a bracket having a first fixing portion fixed to a frame of a motorcycle, a second fixing portion fixed to a cowl with which a motorcyclist comes into contact when riding the motorcycle, and a third fixing portion fixed to the header tank.

2. A heat exchanger for motorcycle use according to claim 1, wherein a portion of the second fixing portion is arranged so as to cover an opposite side of the cowl.

3. A heat exchanger for motorcycle use according to claim 1, wherein the bracket is arranged so as to face the air passage plane of the core portion.

4. A heat exchanger for motorcycle use according to claim 1, wherein the first and second fixing portions are respectively arranged correspond to vertical both sides to the air passage plane of the core portion.

5. A heat exchanger for motorcycle use according to claim 1, wherein the frame is a center frame arranged in a central portion of the motorcycle,
Core portion is arranged on both sides or one side of the center frame, and
a load is applied by pressure from a leg of a motorcyclist to a side of the center frame through the cowl and bracket when the motorcyclist rides the motorcycle.

6. A heat exchanger for motorcycle use according to claim 1, wherein two brackets are arranged so as to respectively correspond to the pair of header tanks.

7. A heat exchanger for motorcycle use according to claim 1, wherein the first fixing portion and the second fixing portion are arranged on opposite sides in the lamination direction of the tube,
the heat exchanger for motorcycle use further comprising a connecting portion for connecting the first fixing portion with the second fixing portion, wherein the connecting portion is arranged between the connecting portion and the core portion at intervals in a ventilating direction.
